(19) United States
(12) Patent Application Publication
(10) Pub. No.: US 2026/0027748 A1
(43) Pub. Date: Jan. 29, 2026

(54) INSULATION FILLING DEVICE FOR FUEL REFORMER

(71) Applicant: JIS Co., Ltd., Daejeon (KR)

(72) Inventor: In Ho KIM, Daejeon (KR)

(21) Appl. No.: 18/894,840

(22) Filed: Sep. 24, 2024

(30) Foreign Application Priority Data
Jul. 29, 2024 (KR) 10-2024-0100104

(51) Int. Cl. B28B 3/14; B01F 23/50; B01F 23/53; B01F 27/92; B01F 27/921; B01F 27/9212; B01F 35/71; B28B 17/02; F16L 59/04; H01M 8/0612

(52) U.S. Cl. CPC B28B 3/14; B01F 23/53; B01F 23/58; B01F 27/9212; B01F 27/9213; B01F 27/923; B01F 35/71731; B01F 35/7179; B28B 17/026; F16L 59/04; H01M 8/0618

(57) ABSTRACT

Embodiments relate to an insulation filling device for a fuel reformer, comprising: a feeder for supplying a powder insulation material; a stirrer for mixing the powder insulation material with a liquid binder for the agglomeration of the particles of the powder insulation material to form an insulation paste; and a thermal molding device for compressing said insulation paste to form a plurality of insulation molds having a predetermined shape and filling the insulation space of the fuel reformer with said insulation molds.

### CROSS-REFERENCE TO RELATED APPLICATIONS

This application claims priority from Korean Patent Application No. 10-2024-0100104, filed on Jul. 29, 2024, in the Korean Intellectual Property Office, which is incorporated herein by reference in its entirety.

### TECHNICAL FIELD

The present invention relates to an insulation filling device for a fuel reformer.

### BACKGROUND ART

A fuel cell is a power generation system that converts the energy from a chemical reaction between hydrogen and an oxidizing agent into electrical energy. Further, hydrogen for use in a fuel cell is obtained by reforming hydrocarbon fuels (e.g., methane, methanol, natural gas, gasoline, and diesel) using a fuel reformer.

FIG. 1 is a drawing showing the insulation space of a fuel reformer filled with a powder insulation material, and FIG. 2 is a drawing showing a powder insulation material in the insulation space of a fuel reformer settling to the bottom due to vibration.

In general, an insulation material is placed in the space between the components provided in the fuel reformer (2) (hereinafter referred to as the “insulation space (2a)”) to prevent the high heat for reforming hydrocarbon fuels from escaping to the outside.

As shown in FIG. 1, when the insulation space (2a) has a complex shape, the insulation space (2a) gets filled with insulation material in powder form (hereinafter referred to as “powder insulation material (11)”) that can easily enter into narrow gaps or areas of the insulation space (2a) that are difficult to artificially access.

However, as illustrated in FIG. 2, when vibration occurs in the fuel reformer (2) during operation, transportation, or other operations of the fuel reformer (2), the powder insulation material (11) gradually settles to the bottom as the voids between the particles become rearranged by the vibration of the fuel reformer (2) and become reduced in size. Accordingly, there was conventionally a problem in that as a result of the powder insulation material (11) in the insulation space (2a) of the fuel reformer (2) settling due to vibration, a dead space (Sd) without any powder insulation material (11) occurred in the insulation space (2a), which reduced the insulation performance of the fuel reformer (2).

### SUMMARY OF INVENTION

### Technical Problem

The present invention is intended to address the above-described problem of the prior art and aims to provide an improved insulation filling device for a fuel reformer that can prevent the settling of the powder insulation material in the insulation space of the fuel reformer.

### Solution to Problem

An insulation filling device for a fuel reformer according to a preferred embodiment of the present invention for solving the above-described problem comprises: a feeder for supplying a powder insulation material; a stirrer for mixing the powder insulation material with a liquid binder for the agglomeration of the particles of the powder insulation material to form an insulation paste; and a thermal molding device for compressing said insulation paste to form a plurality of insulation molds having a predetermined shape and filling the insulation space of the fuel reformer with said insulation molds.

Preferably, said stirrer comprises: a stirring chamber wherein said powder insulation material supplied from said feeder is received; a binder feeding member which supplies said liquid binder to said stirring chamber and brings it into contact with said powder insulation material; and a stirring screw which stirs said powder insulation material and said liquid binder that have been brought into contact with each other by said binder feeding member to form said insulation paste.

Preferably, said stirring chamber is equipped with: an inlet wherein said powder insulation material supplied from said feeder is introduced; a stirring space wherein said powder insulation material passing through said inlet is received and wherein said stirring screw is installed; and an outlet through which said insulation paste formed by said stirring screw in said stirring space is discharged.

Preferably, said inlet is formed to communicate with the upper part of said stirring space, said outlet is formed to communicate with the lower part of said stirring space, and said stirring screw is equipped with: a rotating shaft installed in said stirring space so as to extend from the upper part to the lower part of said stirring space; and a spiral blade coupled to an outer circumferential surface of said rotating shaft so as to be rotatable along the rotating shaft and stir and transport said powder insulation material and said liquid binder toward said outlet.

Preferably, said stirring space is formed so that its diameter gradually decreases from said inlet side toward said outlet side, and said spiral blade is formed so that its outer diameter gradually decreases from said inlet side toward said outlet side.

Preferably, said binder feeding member is installed so as to spray said liquid binder onto said powder insulation material is passed through the upper part of said stirring space by said spiral blade.

Preferably, said liquid binder is water or an aqueous solution of at least one additive dissolved in said water.

Preferably, the invention further comprises a buffer chamber for temporarily storing said insulation paste transferred from said stirrer and transferring it to said thermal molding device.

Preferably, the amount of said insulation paste formed in said stirrer and the amount of said insulation paste molded in said thermal molding device are adjusted so that said insulation paste is layered in said buffer chamber to a predetermined reference height.

Preferably, said thermal molding device is provided with a pair of compression rollers installed facing each other along a direction perpendicular to the conveying direction of said insulation paste and interlock with each other to compress and mold said insulation paste into said insulation molds.

Preferably, said thermal molding device is provided so that said insulation paste transferred from said stirrer is transported by gravity along the direction of the gravitational force, and said compression rollers are installed facing each other along the horizontal direction perpendicular to said direction of the gravitational force so that said insulation paste conveyed along said direction of the gravitational force is layered on top of said compression rollers.

Preferably, said compression rollers have a plurality of molding grooves recessed in the outer circumferential surface so as to have a shape corresponding to said insulation molds.

### Advantageous Effects of Invention

The present invention relates to an insulation filling device for a fuel reformer, wherein a powder insulation material is mixed with a liquid binder to form an insulation paste and the insulation paste is compressed and molded into a plurality of insulation molds, which then fill the insulation space of a fuel reformer, thereby enabling a larger amount of the insulation material to fill the insulation space compared to a case wherein the powder insulation material directly fills the insulation space. However, the insulation molds in the insulation space revert to powder insulation material as the liquid binder evaporates due to the high heat of the fuel reformer, and the powder insulation material fills the insulation space with minimal voids between particles. Through this, the present invention prevents the formation of a dead space without the powder insulation material in the thermal insulation space, which results due to the settling of the powder insulation material in the insulation space caused by the vibration of the fuel reformer, thereby improving the thermal insulation performance of the fuel reformer.

### BRIEF DESCRIPTION OF DRAWINGS

FIG. 1 is a drawing showing a state in which a powder insulation material is filling the insulation space of a fuel reformer.

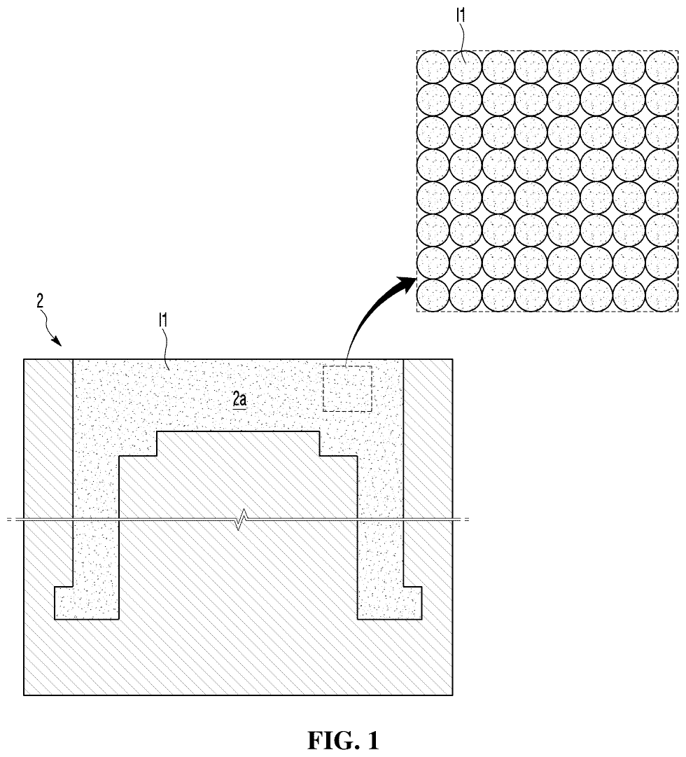

FIG. 2 is a drawing showing a state in which a powder insulation material is filling the insulation space of a fuel reformer has settled due to vibration.

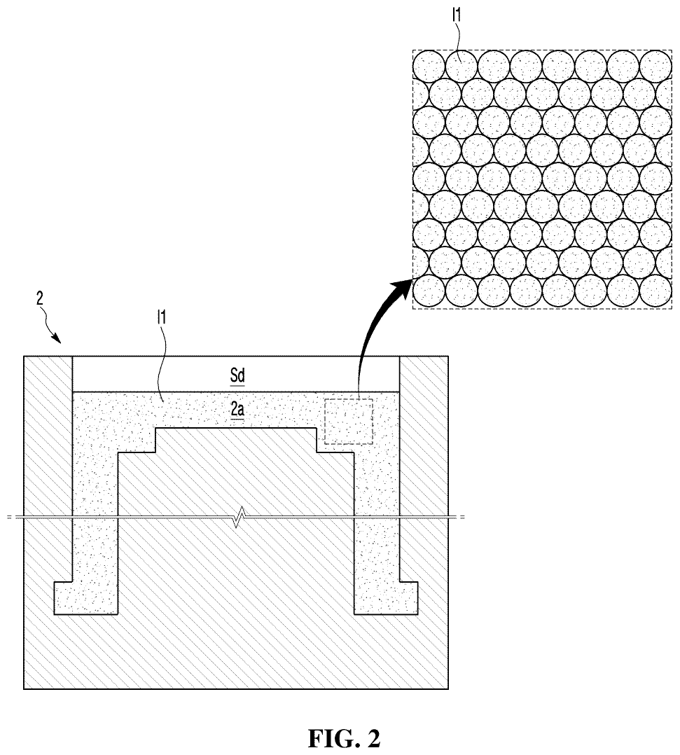

FIG. 3 is a drawing showing a schematic configuration of an insulation filling device for a fuel reformer according to a preferred embodiment of the present invention.

FIG. 4 is a drawing showing a schematic configuration of the feeder illustrated in FIG. 3.

FIG. 5 is a drawing showing the state in which a powder insulation material is stored in the storage chamber of the feeder illustrated in FIG. 4.

FIG. 6 is a drawing showing the shutter of the feeder illustrated in FIG. 4 in an open state.

FIG. 7 is a drawing showing a schematic configuration of the stirrer illustrated in FIG. 3.

FIG. 8 is a drawing showing the powder insulation material and liquid binder being stirred in the stirrer illustrated in FIG. 7 to form an insulation paste.

FIG. 9 is a drawing showing a schematic configuration of the buffer chamber illustrated in FIG. 3.

FIG. 10 is a drawing showing the insulation paste being compressed by its own weight in the buffer chamber illustrated in FIG. 9.

FIG. 11 is a drawing showing a schematic configuration of the pressure molding device and fuel reformer illustrated in FIG. 3.

FIG. 12 is a drawing showing insulation molds being formed by compressing and molding the insulation paste.

FIG. 13 is a perspective view of the compression roller illustrated in FIG. 11.

FIG. 14 a perspective view of a variation of the compression roller illustrated in FIG. 12.

FIG. 15 is a drawing showing insulation molds being formed by compressing and molding an insulation paste using the compression roller illustrated in FIG. 14.

FIG. 16 is a drawing showing the insulation molds being restored into the powder insulation material in the insulation space of a fuel reformer.

FIG. 17 is a drawing showing the powder insulation material restored from the insulation molds filling the insulation space of a fuel reformer.

### DESCRIPTION OF EMBODIMENTS

Hereinafter, some embodiments of the present invention will be described in detail with reference to exemplary drawings. It should be noted that in assigning reference numerals to the components in each drawing, the same components are assigned the same numerals as much as possible, even if they are shown in different drawings. Further, in describing embodiments of the present invention, specific descriptions of related disclosed configurations or features are omitted where it is determined that such detailed description would impede an understanding of the embodiments of the present invention.

In describing components of embodiments of the present invention, terms such as first, second, A, B, (a), (b), etc. may be used. Such terms are only intended to distinguish one component from another, and the nature, order, or sequence of the components are not limited by these terms. Further, unless otherwise defined, all terms used herein, including technical or scientific terms, have the same meaning as commonly understood by persons having ordinary skill in the art to which the present invention belongs. Terms defined in commonly used dictionaries should be construed as having a meaning consistent with the meaning they have in the context of the relevant art and should not be construed in an idealistic or unduly formal sense, unless explicitly defined in this application.

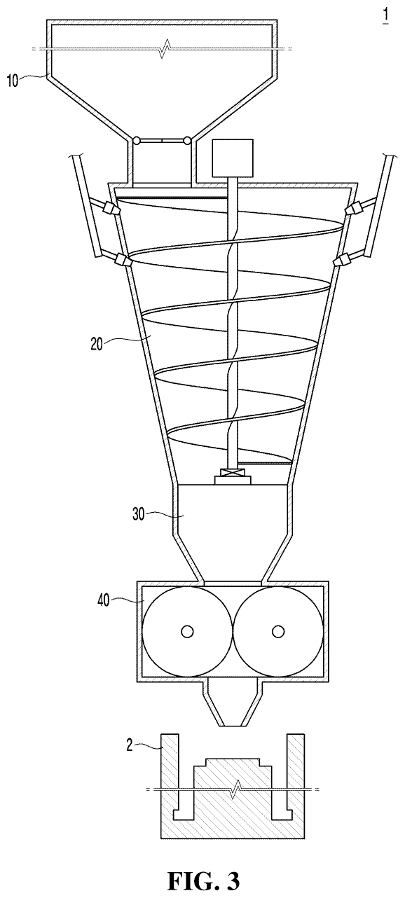

FIG. 3 is a drawing showing a schematic configuration of an insulation filling device for a fuel reformer according to a preferred embodiment of the present invention.

Referring to FIG. 3, an insulation filling device for a fuel reformer (1) according to a preferred embodiment of the present invention may include a feeder (12) for supplying a powder insulation material (11), a stirrer (20) for stirring the powder insulation material (11) supplied from the feeder (12) with a liquid binder (B) to form an insulation paste (I2), a buffer chamber (30) for temporarily storing the insulation paste (I2) formed in the stirrer (20), a pressure molding device (40) for forming insulation molds (I3) by compressing and molding the insulation paste (I2) transferred from the buffer chamber (30) and filling the fuel reformer (2) with the insulation molds (I3).

In this specification, powder insulation material (11) refers to a powder insulation material that is powdered to a predetermined particle size.

The type of powder insulation material (11) that can be put into the insulation space (2a) of the fuel reformer (2) using the insulation filling device for a fuel reformer (1) is not particularly limited. For example, the powder insulation material (11) may be a powder insulation material made of a micro-porous fumed-silica material that has low thermal conductivity and can be used at temperatures of up to about 1,100° C.

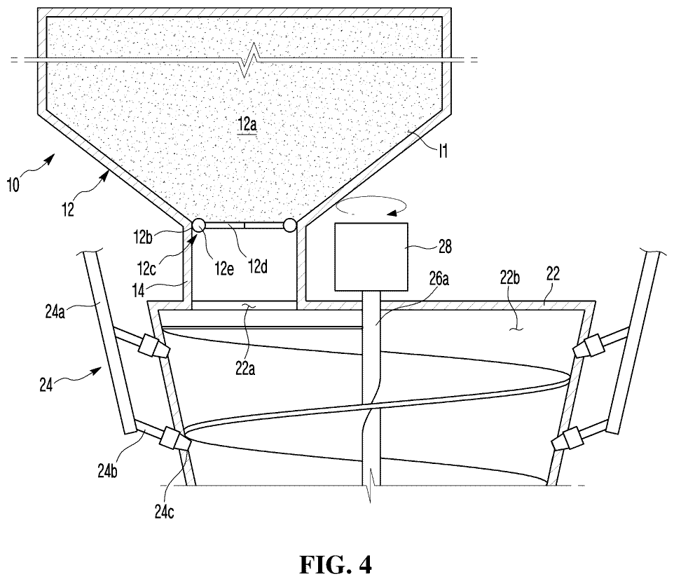

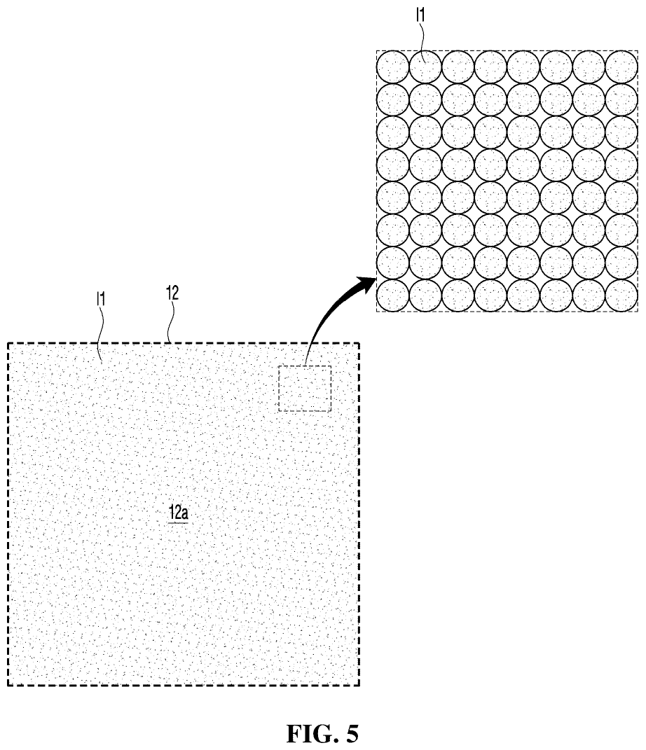

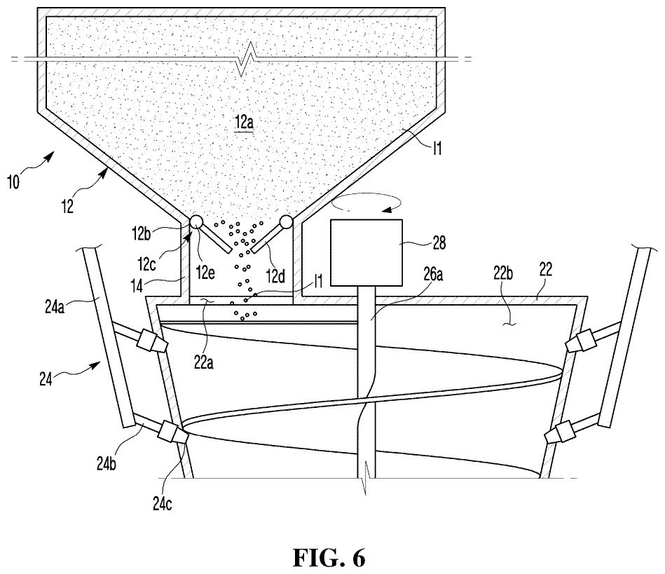

FIG. 4 is a drawing showing a schematic configuration of the feeder shown in FIG. 3, FIG. 5 is a drawing showing the powder insulation material stored in the storage chamber of the feeder illustrated in FIG. 4, and FIG. 6 is a drawing showing the shutter of the feeder shown in FIG. 4 in an open state.

As shown in FIG. 4, the feeder (12) may comprise a storage chamber (12) wherein the powder insulation material (11) is stored and a feeding tube (14) that supplies the powder insulation material (11) discharged from the storage chamber (12) to the stirrer (20).

Further, the storage chamber (12) may have a storage space (12a) in which the powder insulation material (11) is stored, an outlet (12b) through which the powder insulation material (I1) stored in the storage space (12a) is discharged, and a shutter (12c) for opening and closing the outlet (12b).

As shown in FIG. 5, the powder insulation material (11) for filling the insulation space (2a) of the fuel reformer (2) is stored in a storage space (12a).

As shown in FIG. 4, the outlet (12b) is preferably formed through the floor of the storage chamber (12) so as to be in communication with the lower part of the storage space (12a). Correspondingly, the floor of the storage chamber (12) is formed to slope downward toward the outlet (12b), and the feeding tube (14) is installed to connect the outlet (12b) and the inlet (22a) of the stirrer (20), which will be described later. Then, as shown in FIG. 6, when the outlet (12b) is opened by the shutter (12c), which will be described later, the powder insulation material (11) stored in the storage space (12a) is discharged from the storage space (12a) through the outlet (12b) while automatically sliding along the floor of the storage chamber (12) due to its own weight and enters into the inlet (22a) of the stirrer (20), which will be described later, through the feeding tube (14), thereby being supplied to the stirrer (20).

The structure of the shutter (12c) is not particularly limited, and the shutter (12c) is provided so as to close the outlet (12b) to stop the supply of the powder insulation material (11) or open the outlet (12b) to enable the supply of the powder insulation material (11). For example, as illustrated in FIG. 6, the shutter (12c) may have a cover sheet (12d) installed on the outlet (12b) to cover the outlet (12b) with a shape corresponding to the outlet (12b) and a driving member (12e) that rotates the cover sheet (12d) so that the outlet (12b) can be opened or closed by the cover sheet (12d).

Such shutter (12c) can control the amount of powder insulation material (11) supplied by adjusting the degree to which the outlet (12b) is opened according to the manner in which the insulation paste (I2) is formed in the stirrer (20). Through this, the shutter (12c) can prevent damage to the stirrer (20) or deterioration in the quality of the insulation paste (I2) caused by blockage in the flow path of the powder insulation material (11) in the stirrer (20) due to a large amount of the powder insulation material (11) simultaneously pouring out from the outlet (12b) and being supplied to the stirrer (20).

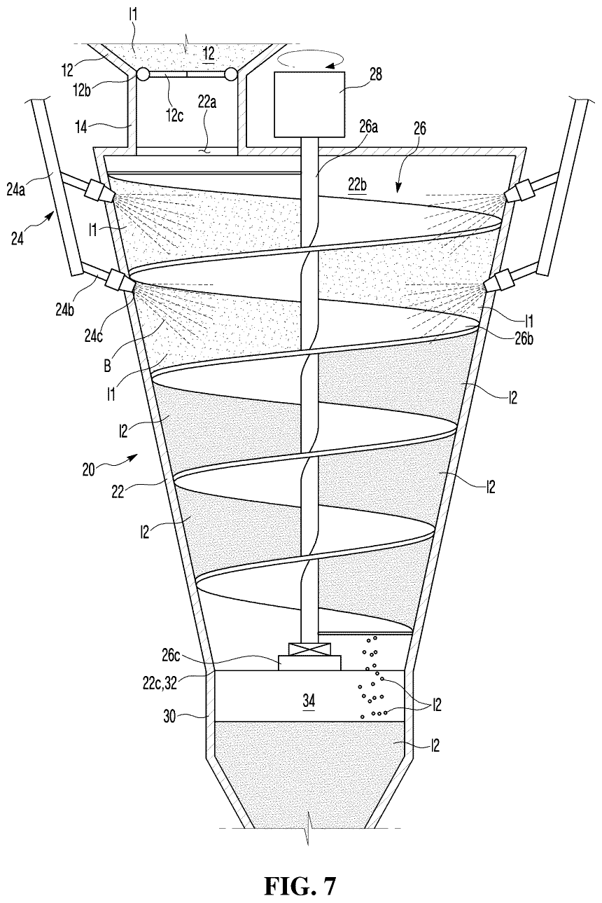

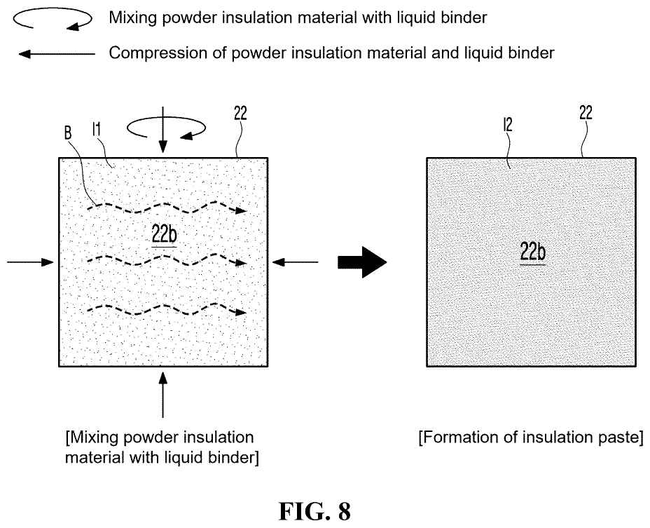

FIG. 7 is a drawing showing a schematic configuration of the stirrer illustrated in FIG. 3, and FIG. 8 is a drawing showing the powder insulation material and liquid binder being stirred in the stirrer illustrated in FIG. 7 to form an insulation paste.

As shown in FIG. 7, the stirrer (20) may be equipped with a stirring chamber (22) where the powder insulation material (11) supplied from the feeder (12) is received, a binder feeding member (24) for supplying liquid binder (B) to the stirring chamber (22), a stirring screw (26) for stirring the powder insulation material (11) and the liquid binder (B) to form an insulation paste (12), and a driving member (28) for rotating the stirring screw (26).

The stirring chamber (22) may have an inlet (22a) through which the powder insulation material (I1) supplied from the feeder (12) is introduced, a stirring space (22b) through which the powder insulation material (11) passing through the inlet (22a) is received, and an outlet (22c) through which the insulation paste (I2) formed in the stirring space (22b) is discharged.

The inlet (22a) is formed through the roof of the stirring chamber (22) so as to be in communication with the upper part of the stirring space (22b) and is connected to the outlet (12b) of the storage chamber (12) by a feeding tube (14). Accordingly, the powder insulation material (11) supplied from the storage chamber (12) can enter into the inlet (22a) while free-falling down the internal flow path of the feeding tube (14) due to gravity in a state isolated from the outside. The powder insulation material (11) introduced into the inlet (22a) is received in the stirring space (22b) as it free-falls due to gravity.

The powder insulation material (11) that has been powdered to a small particle size can easily be scattered by air resistance or other external forces. Accordingly, if the powder insulation material (I1) is supplied through a flow channel open to the atmosphere, the powder insulation material (I1) scattered by air resistance or other external forces may leak out, resulting in loss of the powder insulation material (11), and the powder insulation material (11) leaked externally may cause problems such as illness of workers and environmental pollution.

However, the insulation filling device for a fuel reformer (1) wherein the powder insulation material (11) discharged from the storage chamber (12) is fed into the stirring chamber (22) of the stirrer (20) while being isolated from the outside by a feeding tube (14) can prevent problems caused by the scattering and leakage of the powder insulation material (11).

The shape of the stirring space (22b) is not particularly limited. For example, as shown in FIG. 7, the stirring space (22b) may be formed so that its diameter gradually decreases from the upper part in communication with the inlet (22a) to the lower part in communication with the outlet (22c). In this case, the stirring chamber (22) may have a cylindrical shape whose diameter gradually decreases from the roof where the inlet (22a) is formed to the floor where the outlet (22c) is formed.

The outlet (22c) is formed through the floor of the stirring chamber (22) so as to be in communication with the lower part of the stirring space (22b) and is connected to the buffer chamber (30), which will be described later.

In the case where the inlet (22a) is formed to communicate with the upper part of the stirring space (22b) and the outlet (22c) is formed to communicate with the lower part of the stirring space (22b) as described above, the powder insulation material (I1) supplied from the feeder (12) to the stirring space (22b) and the insulation paste (I2) formed by the stirring screw (26) can be transported in the direction of the gravitational force. Further, the insulation paste (I2) detached from the stirring screw (26) can be discharged from the stirring space (22b) through the outlet (22c) by free-falling due to gravity and be transferred to the buffer chamber (30).

The binder feeding member (24) may be equipped with a feeding tube (24a) connected to an external liquid binder supply source (not shown), and a spray nozzle (24b) that sprays the liquid binder (B) supplied via the feeding tube (24a) into the stirring space (22b) in the form of fine particles.

The liquid binder (B) may comprise a material that exists in a liquid state at room temperature, can agglomerate particles of the powder insulation material (11) to form an insulation paste (I2) having a higher bulk density than the powder insulation material (11), and when heated, evaporates and escapes from the insulation molds (I3), which will be described later, so that the insulation molds (I3) are restored into the powder insulation material (11). For example, the liquid binder (B) may be water or an aqueous solution wherein at least one additive is dissolved as a solute in water as a solvent.

Here, bulk density refers to the density calculated by taking the volume of the container as the volume of the powder when the powder fills a container of a specific volume. According to this method of calculating bulk density, the volume of the voids between the particles of the powder is included in the volume of the powder, so even if the mass of the powder remains the same, the bulk density of the powder can increase or decrease depending on the volume of the voids created between the particles of the powder.

It is preferable that the liquid binder (B) be supplied in a room-temperature state so that sintering can be performed at room temperature using the liquid binder (B) to form the insulation paste (I2) and insulation molds (I3) from the powder insulation material (11), but a preferable embodiment is not limited thereto.

The number of supply pipes (24a) installed is not particularly limited. For example, a plurality of supply pipes (24a) may be installed outside the stirring chamber (22) at predetermined angular intervals facing the side wall of the stirring chamber (22).

The number of spray nozzles (24b) installed is not particularly limited. For example, a plurality of spray nozzles (24b) may be installed at predetermined intervals along the height of the stirring chamber (22) for each of the supply pipes (24a).

The method of installing the spray nozzles (24b) is not particularly limited.

For example, the spray nozzles (24b) may be installed so that each spray port (24c) for spraying the liquid binder (B) supplied from a feeding tube (24a) penetrates the side wall of the stirring chamber (22) and communicates with the stirring space (22b).

For example, the spray nozzles (24b) may be installed so as to be inclined at a predetermined angle so as to spray the liquid binder (B) at a tilt toward the direction in which the powder insulation material (11) is transported so that the powder insulation material (11) and the liquid binder (B) can smoothly come into contact with each other. More specifically, where a stirrer (20) is provided so that the powder insulation material (11) supplied to the stirring space (22b) can be transported in the direction of the gravitational force, the spray nozzles (24b) may be installed so as to be inclined downward at a predetermined angle to tilt toward the direction of the gravitational force.

For example, the spray nozzles (24b) may each be installed so that the spray ports (24c) do not collide with the spiral blade (26b) and other components provided in the stirring screw (26), which will be described later, by a predetermined clearance from the components provided in the stirring screw (26).

The installation positions of the spray nozzles (24b) are not particularly limited. For example, the spray nozzles (24b) may be installed with the spray ports (24c) positioned at the upper part of the stirring space (22b) so as to spray the liquid binder (B) toward the powder insulation material (11) passing through the upper part of the stirring space (22b).

The amount of liquid binder (B) supplied by the binder feeding member (24) is not particularly limited, and the amount of liquid binder (B) supplied can be adjusted according to the amount of powder insulation material (11) supplied per unit time, the composition of the powder insulation material (11), the reference water content of the insulation paste (I2) and the insulation molds (I3), the composition of the liquid binder (B), etc.

The stirring screw (26) may have a rotating shaft (26a) that is axially coupled with a driving member (28) and rotationally driven by the driving member (28), a spiral blade (26b) that is coupled to an outer circumferential surface of the rotating shaft (26a) so that it can be rotationally driven along the rotating shaft (26a) and extends in a spiral shape along the longitudinal direction of the rotating shaft (26a), and a rotation support member (26c) that provides support so that the rotating shaft (26a) can rotate.

The rotating shaft (26a) is installed along the height of the stirring chamber (22) in the stirring space (22b) so that one end penetrates the roof of the stirring chamber (22) and extends to the outside of the stirring chamber (22) and the other end opposite to the above-mentioned one end extends to the outlet (22c). Further, one end of the rotating shaft (26a) extending to the outside of the stirring chamber (22) is axially coupled to the driving member (28). Through this, the rotating shaft (26a) can be rotationally driven by the driving member (28).

The spiral blade (26b) is provided to have an outer diameter equal to the diameter of the stirring space (22b) or to have a diameter that is smaller than the diameter of the stirring space (22b) by a predetermined margin so that the powder insulation material (11) cannot pass between the end of the spiral blade (26b) and the inner surface of the stirring space (22b) without being mixed with the liquid binder (B). Further, as described above, where the stirring space (22b) is provided to have a diameter that gradually decreases from the upper part to the bottom, the spiral blade (26b) may correspondingly be provided to have an outer diameter that gradually decreases from the upper part to the bottom.

The rotation support member (26c) is installed in a fixed state in the stirring space (22b) so as to provide support so that the other end of the rotating shaft (26a) can rotate.

The structure of the rotation support member (26c) is not particularly limited. For example, the rotation support member (26c) may comprise at least one member capable of supporting the rotation of a bearing or other rotating shaft (26a).

Hereinafter, with reference to FIGS. 7 and 8, the manner in which an insulation paste (I2) is formed from a powder insulation material (11) in a stirrer (20) will be described.

First, the powder insulation material (11) enters the upper part of the stirring space (22b) through the inlet (22a) and begins to be transported toward the outlet (22c) while being rotated around the rotating shaft (26a) by the spiral blade (26b) of the stirring screw (26).

Next, the powder insulation material (11) comes into contact with the liquid binder (B) sprayed from the spray port (24c) of each of the spray nozzles (24b) while passing through the upper part of the stirring space (22b).

Thereafter, the powder insulation material (11) and the liquid binder (B) are transported together toward the outlet (22c) while being stirred and compressed by the spiral blade (26b), and during the stirring and transportation process of the powder insulation material (11) and the liquid binder (B), room-temperature sintering occurs and the particles of the powder insulation material (11) are agglomerated by the liquid binder (B), resulting in the formation of an insulation paste (I2) having a higher bulk density than the powder insulation material (11) from the powder insulation material (I1).

Next, the insulation paste (I2) is transported toward the outlet (22c) by the spiral blade (26b) and then detached from the spiral blade (26b) at the lower part of the spiral blade (26b).

Thereafter, the insulation paste (I2) is discharged from the stirring space (22b) through the outlet (22c) while free-falling due to gravity and then transferred to the buffer chamber (30).

Meanwhile, as described above, the diameter of the stirring space (22b) gradually decreases toward the outlet (22c). Accordingly, as illustrated in FIG. 8, in the process of transporting the powder insulation material (I1) and the insulation paste (I2) toward the outlet (22c), the pressure applied by the spiral blade (26b) to the powder insulation material (11) and the insulation paste (I2) gradually increases. Through this, the bulk density of the insulation paste (I2) can increase further.

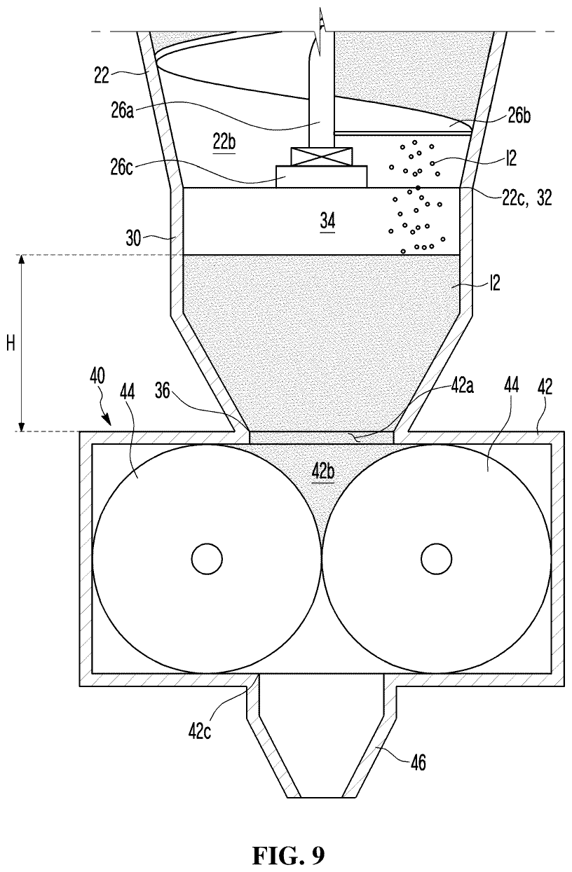

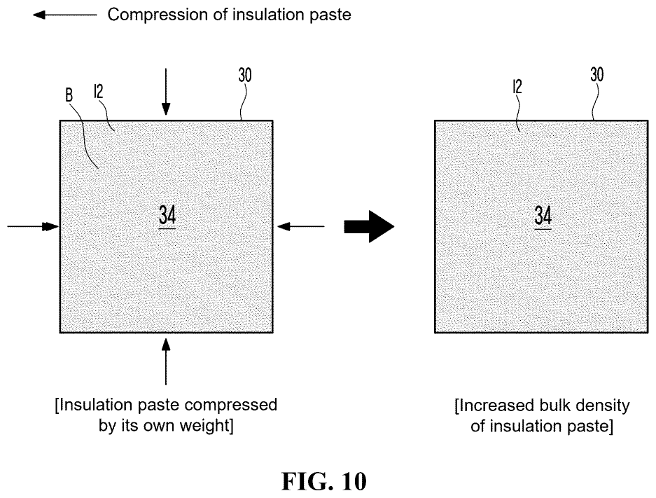

FIG. 9 is a drawing showing a schematic configuration of the buffer chamber illustrated in FIG. 3, and FIG. 10 is a drawing showing the insulation paste being compressed by its own weight in the buffer chamber illustrated in FIG. 9.

As shown in FIG. 9, the buffer chamber (30) is provided so that the insulation paste (I2) transferred from the stirrer (20) through the outlet (22c) of the stirring chamber (22) can be temporarily stored and then transferred to the pressure molding device (40).

This buffer chamber (30) may be equipped with an inlet (32) into which the insulation paste (I2) discharged from the outlet (22c) of the stirring chamber (22) enters, a buffer space (34) wherein the insulation paste (I2) passing through the inlet (32) is temporarily stored, and an outlet (36) through which the insulation paste (I2) passing through the buffer space (34) is discharged.

The inlet (32) may be formed through the roof of the buffer chamber (30) so as to be aligned with the outlet (22c) of the stirring chamber (22) but communicate with the upper part of the buffer space (34). Accordingly, the insulation paste (I2) detached from the lower part of the spiral blade (26b) may enter into the inlet (32) through the outlet (22c) by free-falling due to gravity.

The buffer space (34) has a predetermined volume so as to temporarily store the insulation paste (I2) for a predetermined reference time.

As shown in FIG. 10, it is preferable that the buffer space (34) be provided so that the bulk density of the insulation paste (I2) further increases as the insulation paste (I2) is compressed by its own weight while the insulation paste (I2) is temporarily stored for the above-mentioned reference time.

To this end, as shown in FIG. 9, it is preferable that the buffer space (34) be provided so that the insulation paste (I2) can be temporarily stored in a state where it is layered to a predetermined reference height (H) in order to ensure a certain level of self-weight necessary to compress the insulation paste (I2) by a predetermined ratio using its own weight.

Further, the controller of the insulation filling device for a fuel reformer (1) can control the amount of insulation paste (I2) formed per unit time by the stirrer (20) described above and the amount of insulation paste (I2) molded per unit time by the pressure molding device (40) described below so that the insulation paste (I2) can be temporarily stored in a state in which it is layered to the reference height (H) in the buffer space (34).

For example, if the height of the layered insulation paste (I2) in the buffer space (34) exceeds the reference height (H), the controller can reduce the height of the layered insulation paste (I2) to the reference height (H) by reducing the amount of the insulation paste (I2) formed per unit time by the stirrer (20) or increasing the amount of the insulation paste (I2) molded per unit time by the pressure molding device (40).

Further, the amount of insulation paste (I2) formed per unit time by the stirrer (20) can be reduced by a method of reducing the amount of powder insulation material (11) supplied per unit time by the feeder (12) by reducing the degree to which the outlet (12b) of the storage chamber (12) is opened using the shutter (12c), a method of reducing the rotational speed of the spiral blade (26b) using the driving member (28) of the stirrer (20) to reduce the speed at which powder insulation material (11) is stirred and conveyed by the spiral blade (26b), etc.

Further, the amount of insulation paste (I2) molded per unit time by the pressure molding device (40) can be increased by a method of increasing the rotational speed of the compression roller (44) to be described later, etc.

For example, if the height of the layered insulation paste (I2) in the buffer space (34) is less than the reference height (H), the controller can increase the height of the layered insulation paste (I2) to the reference height (H) by increasing the amount of the insulation paste (I2) formed per unit time by the stirrer (20) or decreasing the amount of the insulation paste (I2) molded per unit time by the pressure molding device (40).

Further, the amount of insulation paste (I2) formed per unit time by the stirrer (20) can be increased by a method of increasing the amount of powder insulation material (11) supplied per unit time by the feeder (12) by increasing the degree to which the outlet (12b) of the storage chamber (12) is opened using the shutter (12c), a method of increasing the rotational speed of the spiral blade (26b) by using the driving member (28) of the stirrer (20) to increase the speed at which the powder insulation material (11) is stirred and conveyed by the spiral blade (26b), etc.

Further, the amount of the insulation paste (I2) molded per unit time by the pressure molding device (40) can be reduced by a method of reducing the rotational speed of the compression roller (44), which will be described later, etc.

The outlet (36) is formed through the floor of the buffer chamber (30) so as to be in communication with the lower part of the buffer space (34) and is connected to a pressure molding device (40) to be described later. Correspondingly, the floor of the buffer chamber (30) may be formed to slope downward toward the outlet (36) so that the cross-sectional area of the buffer space (34) decreases toward the outlet (36). When the buffer chamber (30) is provided so that the cross-sectional area of the buffer space (34) decreases toward the outlet (36), the pressure applied to the insulation paste (I2) by its own weight increases further and the bulk density of the insulation paste (I2) may increase further as a result. Further, the insulation paste (I2) may be automatically transported toward the outlet (36) by gravity and then transferred to the pressure molding device (40) through the outlet (36).

Alternatively, the buffer chamber (30) described above may be omitted. In this case, the stirrer (20) may be directly connected to the pressure molding device (40) so that the insulation paste (I2) formed in the stirrer (20) can be directly transferred to the pressure molding device (40).

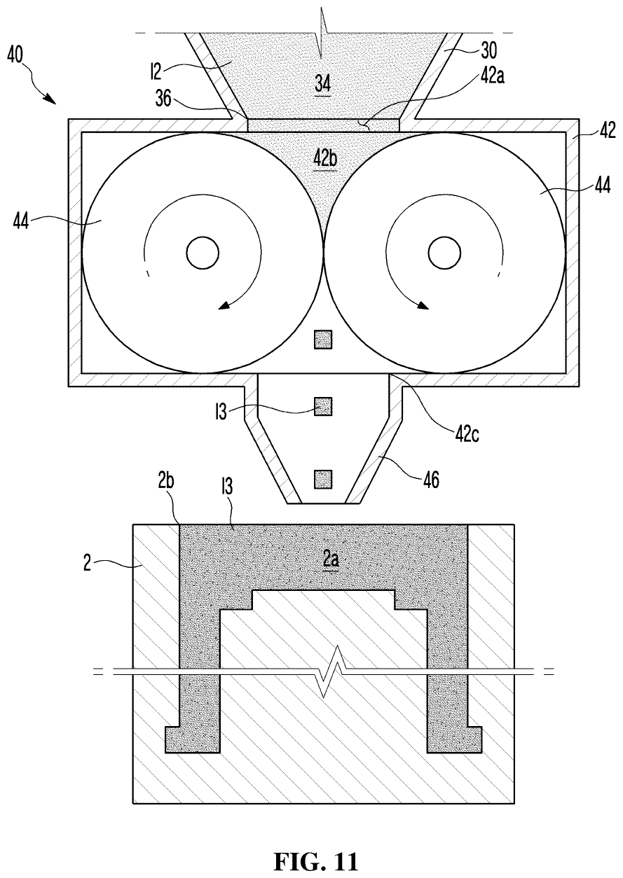

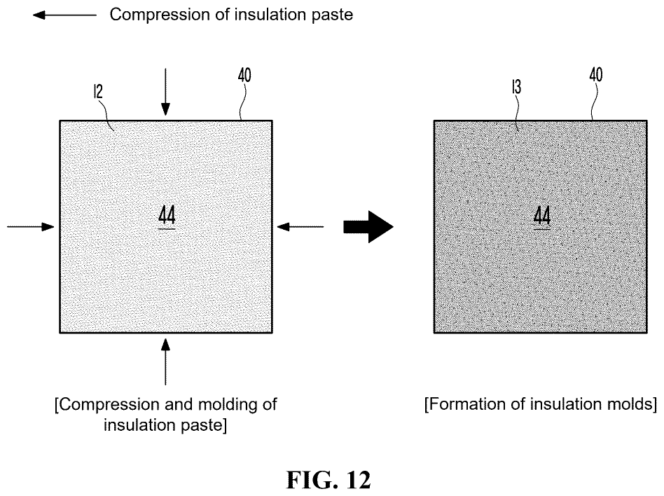

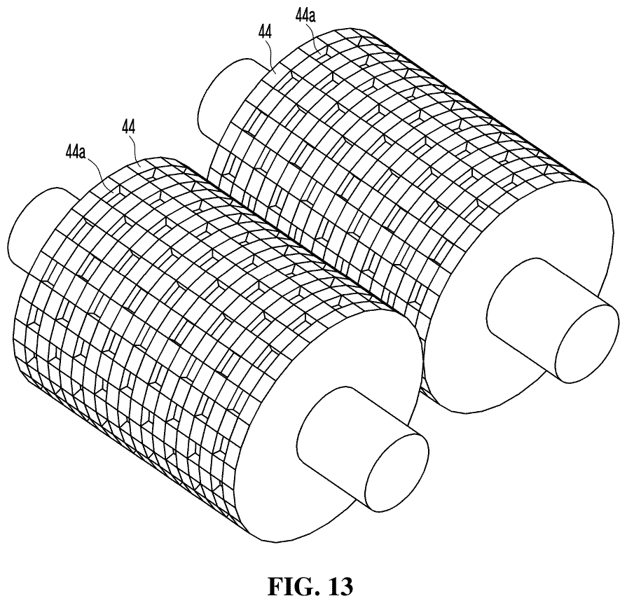

FIG. 11 is a drawing showing a schematic configuration of the pressure molding device and fuel reformer illustrated in FIG. 3, FIG. 12 is a drawing showing insulation molds being formed by compressing and molding the insulation paste, and FIG. 13 is a perspective view of the compression roller illustrated in FIG. 11.

As shown in FIG. 11, the pressure molding device (40) may be equipped with a compression chamber (42) that provides a space for forming an insulation paste (I2) transferred from a buffer chamber (30), a compression roller (44) that forms insulation molds (I3) by compressing and molding the insulation paste (I2), and a filling tube (46) that fills the insulation space (2a) of the fuel reformer (2) with the insulation molds (I3) formed by the compression roller (44).

The compression chamber (42) may have an inlet (42a) through which the insulation paste (12) transferred from the buffer chamber (30) enters, a compression space (42b) through which the insulation paste (I2) passing through the inlet (42a) is received, and an outlet (42c) through which the insulation molds (I3) formed in the compression space (42b) are discharged.

The inlet (42a) may penetrate through the roof of the compression chamber (42) so as to be aligned with the outlet (36) of the buffer chamber (30) but communicate with the upper part of the compression space (42b). Accordingly, the insulation paste (I2) passing through the outlet (36) of the buffer chamber (30) may enter into the inlet (42a) and then transferred to the compression space (42b).

The compression space (42b) is provided to have a larger volume than the volume of the compression roller (44) so that the compression roller (44) can be installed in the compression space (42b).

The outlet (42c) penetrates through the floor of the compression chamber (42) so as to be in communication with the lower part of the compression space (42b) and is connected to the filling tube (46). In particular, the outlet (42c) is preferably formed to face the inlet (42a) in the direction of the gravitational force with the compression roller (44), which will be described later, placed in between so that the insulation paste (I2) transferred to the compression space (42b) through the inlet (42a) is shaped into insulating molds (I3) by the compression roller (44) while moving in the direction of the gravitational force due to gravity and the insulating molds (I3) reach the outlet (42c) by moving in the direction of the gravitational force due to gravity.

The compression roller (44) is provided so as to form insulation molds (I3) having a predetermined shape by compressing and molding the insulation paste (I2) transferred to the compression space (42b) through the inlet (42a). For example, the pressure molding device (40) may be provided with a pair of compression rollers (44) that are installed facing each other in the horizontal direction perpendicular to the direction of the gravitation force and are capable of forming insulation molds (I3) by compressing and molding the insulation paste (I2) in conjunction with each other.

It is preferable that the compression rollers (44) are installed in between the inlet (42a) and the outlet (42c) in a horizontal direction facing each other. Then, as shown in FIG. 11, the insulation paste (I2) entering the compression space (42b) through the inlet (42a) is layered on top of the compression rollers (44). As shown in FIG. 12, the compression rollers (44) can form insulation molds (I3) having a large bulk density compared to the insulating material paste (I2) from the insulating material paste (I2) by sequentially molding the insulation paste (I2) layered on top of the compression rollers (44) in the layering sequence.

Further, as illustrated in FIG. 11, the controller can control the amount of insulation paste (12) formed per unit time by the stirrer (20) and the amount of insulation paste (I2) molded per unit time by the pressure molding device (40) so that the insulation paste (I2) can be temporarily stored in the layered state up to the reference height (H) of the buffer space (34) above the compression rollers (44).

The insulation molds (I3) preferably have a shape that allows easy entry into easily enter narrow gaps or areas that are difficult to artificially access in the insulation space (2a) provided in a fuel reformer (2). For example, as illustrated in FIG. 11, the insulation molds (I3) may have a polygonal block shape. When the insulation molds (I3) are formed into a polygonal block shape as such, the size of the insulation molds (I3) is not particularly limited and may be adjusted depending on the processability, workability, filling efficiency, etc. of the insulation molds (I3).

As shown in FIG. 13, in the case where the insulation molds (I3) have a polygonal block shape, the compression rollers (44) may each have a plurality of molding grooves (44a) recessed at predetermined intervals on the outer circumferential surface so as to have a shape corresponding to the insulation molds (I3). In this case, it is preferable that the molding grooves (44a) of one of the compression rollers (44) and the molding grooves (44a) of the other are formed to be staggered from each other, but a preferable embodiment is not limited thereto.

As shown in FIG. 11, the compression rollers (44) rotate in opposite directions so as to induce the insulation paste (I2) layered on the compression n rollers (44) to move toward the outlet (42c). As a result, the insulation paste (I2) layered on top of the compression rollers (44) are guided into the molding groove (44a) by the compression rollers (44) and then compressed by the compression rollers (44) to fit into the shape of the molding grooves (44a), thereby being molded into insulation molds (I3) having a polygonal block shape corresponding to the shape of the molding grooves (44a) and having a higher bulk density compared to the insulation paste (I2). In this way, when the compression rollers (44) are rotated so that the molding grooves (44a) in which the insulation molds (I3) are accommodated face the outlet (42c), the plurality of insulation molds (I3) can be automatically detached from the molding grooves (44a) due to gravity and then free-fall toward the outlet (42c).

The filling tube (46) is connected to the outlet (42c) so as to extend in the direction of the gravitation force from the outlet (42c). Correspondingly, the fuel reformer (2) is arranged so that the opening (2b) of the insulation space (2a) faces the outlet of the filling tube (46). When this is the case, the insulation molds (I3) that have entered the feeding tube (14) through the outlet (42c) of the compression chamber (42) can be discharged from the filling tube (46) while free-falling due to gravity and fill the insulation space (2a) through the opening (2b) of the insulation space (2a). However, the insulation molds (I3) are composed of an insulation paste (I2) formed by mixing ae powder insulation material (11) and a liquid binder (B). Accordingly, the insulation molds (I3) can change shape according to the shape of the insulation space (2a) or flow along the insulation space (2a) so as to fill up narrow gaps or the areas of the insulation space (2a) that are difficult to artificially access.

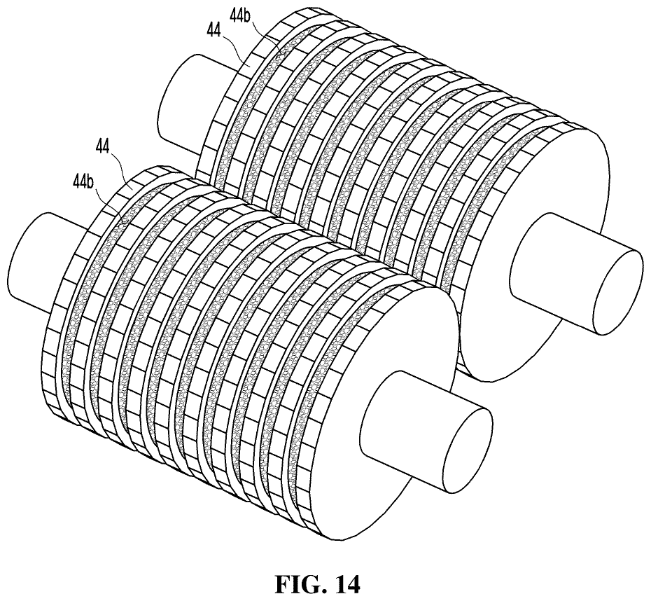

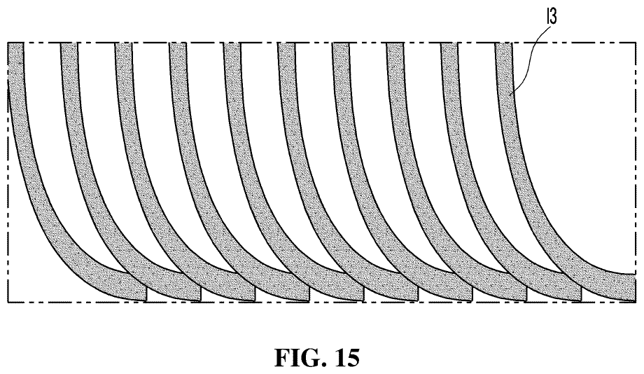

FIG. 14 is a perspective view of a variation of the pressure roller illustrated in FIG. 12, and FIG. 15 is a drawing showing insulation molds being formed by compressing and molding the insulation paste using the compression roller shown in FIG. 14.

As shown in FIG. 14, the compression rollers (44) may be varied structurally to form linear insulation molds (I3) that are elongated along the longitudinal direction. In this case, the compression rollers (44) may have a plurality of molding grooves (44b) that are formed at predetermined intervals and have a ring shape that is recessed along the circumference of the outer circumferential surface, instead of the molding grooves (44a) described above. In this case, as illustrated in FIG. 15, the insulation paste (I2) that has reached the compression rollers (44) gets guided by the compression rollers (44) into the molding grooves (44b) and then compressed to fit the shape of the molding grooves (44b), thereby becoming linear insulation molds (I3).

When forming insulation molds (I3) in a linear shape, the cross-sectional area of the insulation molds (I3) is not particularly limited and can be adjusted depending on the processability, filling efficiency, shape retention performance, etc. of the insulation molds (I3).

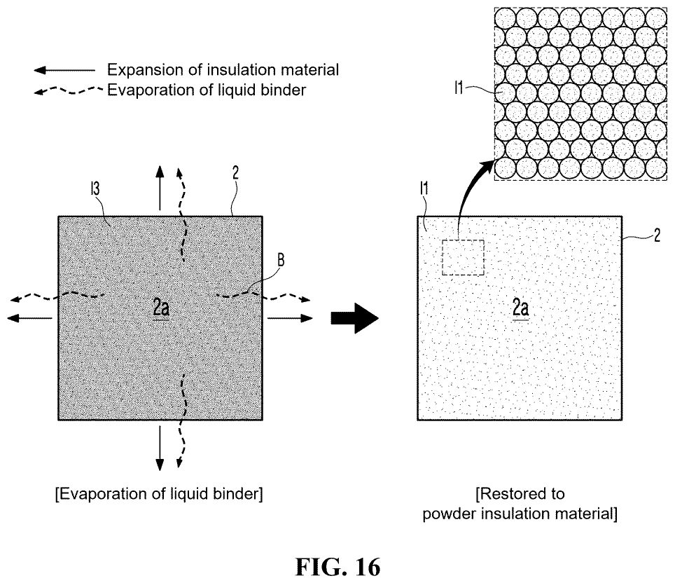

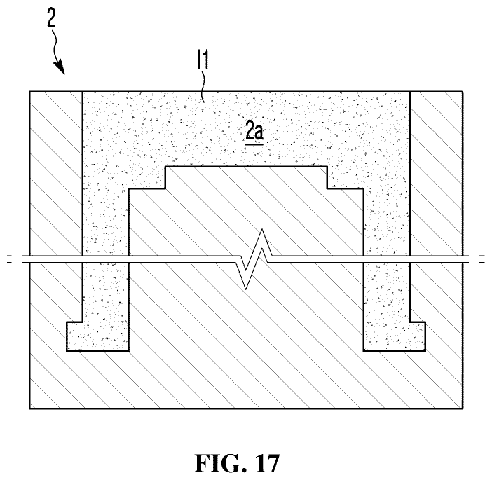

FIG. 16 is a drawing showing the insulation molds being restored into the powder insulation material in the insulation space of a fuel reformer, and FIG. 17 is a drawing showing the powder insulation material restored from the insulation molds filling the insulation space of a fuel reformer.

As shown in FIG. 16, when the fuel reformer (2) is driven while the insulation molds (I3) are in the insulation space (2a), the high heat of the fuel reformer (2) for reforming hydrocarbon fuel is applied to the insulation molds (I3). Accordingly, the liquid binder (B) contained in the insulation molds (I3) is evaporated due to the high heat of the fuel reformer (2), released from the insulation molds (I3), and discharged outside of the fuel reformer (2). Then, the insulation molds (I3) from which the liquid binder (B) has been released are restored to the powder insulation material (11) as they expand due to the high heat of the fuel reformer (2).

However, the insulation molds (I3) are formed to have a higher bulk density than the powder insulation material (11) through a room-/temperature sintering process using a liquid binder (B) and a compression process using a stirring screw (26), a buffer chamber (30), a compression roller (44), etc. When such insulation molds (I3) fill the insulation space (2a), the insulation space (2a) can be filled with a larger amount of insulation material compared to a case where the insulation space (2a) is directly filled with the powder insulation material (11) without a process of forming the insulation molds (I3). Accordingly, as illustrated in FIG. 17, the powder insulation material (11) restored from the insulation molds (I3) fills the insulation space (2a) in a state of high bulk density (in other words, a state where the voids between the particles of the powder insulation material (11) are minimized) compared to a case where the powder insulation material (I1) directly fills the insulation space (2a).

In this way, when the powder insulation material (11) fills the insulation space (2a) with the voids between the particles minimized by using the insulation molds (I3) as a medium, it is difficult for the particles to flow in the direction in which the voids between the particles decrease. Accordingly, according to the insulation filling device (1) for a fuel reformer, when vibration occurs in the fuel reformer (2) during operation, transportation, or other operations of the fuel reformer (2), the phenomenon in which the powder insulation material (11) settles as the particles are rearranged in the direction in which the voids between the particles become smaller is prevented from occurring. Through this, the insulation filling device for a fuel reformer (1) prevents the powder insulation material (11) in the insulation space (2a) from settling due to the vibration of the fuel reformer (2) and creating a dead space from being created in the insulation space (2a), thereby improving the insulation performance of the fuel reformer (2).

Hereinafter, a method of filling the insulation space (2a) of a fuel reformer (2) with a powder insulation material (11) via insulation molds (I3) using the insulation material filling device for a fuel reformer (1) will be described.

First, by opening the outlet (12b) of a storage chamber (12) using a shutter (12c), the powder insulation material (I1) stored in the storage chamber (12) is fed into the stirring chamber (22).

Next, a liquid binder (B) is supplied to the stirring chamber (22) using a binder feeding member (24), so that the powder insulation material (11) come into contact with a liquid binder (B), and the powder insulation material (11) and the liquid binder (B) are stirred using a stirring screw (26) to form an insulation paste (I2) having a higher bulk density than the powder insulation material (I1).

Thereafter, the insulation paste (I2) is temporarily stored in a buffer chamber (30) to further increase the bulk density of the insulation paste (I2) by utilizing its own weight.

Next, the insulation paste (I2) is compressed and molded using a compression roller (44) in a pressure molding device (40) to form insulation molds (I3) having a higher bulk density than the insulation paste (I2).

Afterwards, the insulation space (2a) is filled with the insulation molds (I3) through the opening (2b) of the insulation space (2a).

Next, by using the high heat of the fuel reformer (2) to evaporate the liquid binder (B) contained in the insulation molds (I3) and restore the insulation molds (I3) to the powder insulation material (11), the insulation space (2a) of the fuel reformer (2) is filled with the powder insulation material (11) with minimal voids between particles.

The above description is merely an example of a technical idea of the present invention, and those skilled in the art to which the present invention belongs will be able to make various modifications and variations without departing from the essential characteristics of the present invention.

Therefore, the embodiments disclosed herein are intended to illustrate and not to limit the technical ideas of the invention, and the scope of the technical ideas of the invention is not limited by these embodiments. The scope of protection of the present invention should be construed in accordance with the following claims, and all technical ideas within the equivalent scope should be construed as being included in the scope of the rights of the present invention.

### EXPLANATION OF SYMBOLS

[Explanation of Symbols]

| | |
|---|---|
| 1: Insulation filling device for fuel | |
| reformer | |
| 2: Fuel reformer | |
| 2a: Insulation space | 2b: Opening |
| 10: Feeder | |
| 12: Storage chamber | 12a: Storage space |
| 12b: Outlet | 12c: Shutter |
| 12d: Cover sheet | 12e: Driving member |
| 14: Feeding tube | |
| 20: Stirrer | |
| 22: Stirring chamber | 22a: Inlet |
| 22b: Stirring space | 22c: Outlet |
| 24: Binder feeding member | 24a: Feeding tube |
| 24b: Spray nozzle | 24c: Spray port |
| 26: Stirring screw | 26a: Rotating shaft |
| 26b: Spiral blade | 26c: Rotation support member |
| 28: Driving member | |
| 30: Buffer chamber | |
| 32: Inlet | 34: Buffer space |
| 36: Outlet | |
| 40: Pressure molding device | |
| 42: Compression chamber | 42a: Inlet |
| 42b: Compression space | 42c: Outlet |
| 44: Compression roller | 44a, 44b: Molding groove |
| 46: Filling tube | |
| I1: Powder insulation material | |
| I2: Insulation paste | |
| I3: Insulation molds | |

1. An insulation filling device for a fuel reformer comprising:
a feeder for supplying a powder insulation material;
a stirrer for forming an insulation paste by mixing the powder insulation material with a liquid binder for agglomerating particles of the powder insulation material; and
a thermal molding device that compressing and molding the insulation paste into a plurality of insulation molds having a predetermined shape and filling the insulation space of a fuel reformer with the insulation molds.

2. The insulation filling device for a fuel reformer in claim 1 wherein:
said stirrer is equipped with:
a stirring chamber wherein said powder insulation material supplied from said feeder is received;
a binder feeding member for supplying said liquid binder to said stirring chamber to bring it into contact with said powder insulation material; and
a stirring screw for stirring said powder insulation material and said liquid binder, which have been brought into contact with each other by said binder feeding member, to form said insulation paste.

3. The insulation filling device for a fuel reformer in claim 2 wherein:
the above stirring chamber comprises:
an inlet through which said powder insulation material supplied from said feeder enters;
a stirring space where said powder insulation material passing through said inlet is received and said stirring screw is installed; and
an outlet through which said insulation paste formed by said stirring screw in said stirring space is discharged.

4. The insulation filling device for a fuel reformer in claim 3 wherein:
said inlet is formed to communicate with the upper part of the stirring space and said outlet is formed to communicate with the lower part of the stirring space;
said stirring screw comprises:
a rotating shaft installed in said stirring space so as to extend from the upper part to the lower part of said stirring space; and
a spiral blade coupled to the outer circumferential surface of said rotating shaft so as to be rotationally driven along said rotating shaft and stir and transport said powder insulation material and said liquid binder toward said outlet.

5. The insulation filling device for a fuel reformer in claim 4 wherein:
said stirring space is formed to have a diameter that gradually decreases from said inlet side toward said outlet side; and
said spiral blade is formed to have an outer diameter that gradually decreases from said inlet side toward said outlet side.

6. The insulation filling device for a fuel reformer in claim 4 wherein:
said binder feeding member is installed so as to spray said liquid binder onto said powder insulation material being passed through the upper portion of said stirring space by said spiral blade.

7. The insulation filling device for a fuel reformer in claim 1 wherein:
said liquid binder is water or an aqueous solution in which at least one additive is dissolved in said water.

8. The insulation filling device for a fuel reformer in claim 1 further comprising:
a buffer chamber for temporarily storing said insulation paste transferred from said stirrer and transferring it to said thermal molding device.

9. The insulation filling device for a fuel reformer in claim 8 wherein:
the amount of said insulation paste formed in said stirrer and the amount of said insulation paste molded in said thermal molding device are adjusted so that said insulation paste is layered in said buffer chamber to a predetermined reference height.

10. The insulation filling device for a fuel reformer in claim 1 wherein:
said thermal molding device is provided with a pair of compression rollers installed facing each other along a direction perpendicular to the conveying direction of said insulation paste and interlock with each other to compress and mold said insulation paste into said insulation molds.

11. The insulation filling device for a fuel reformer in claim 10 wherein:
said thermal molding device is arranged so that said insulation paste transferred from said stirrer is transported by gravity along the direction of the gravitational force, and said compression rollers are installed facing each other along the horizontal direction perpendicular to said direction of the gravitational force so that said insulation paste conveyed along said direction of the gravitational force is layered on top of said compression rollers.

12. The insulation filling device for a fuel reformer in claim 10 wherein:
said compression rollers have a plurality of molding grooves recessed in the outer circumferential surface so as to have a shape corresponding to said insulation molds.
